(19) United States
(12) Patent Application Publication
(10) Pub. No.: US 2007/0041112 A1
(43) Pub. Date: Feb. 22, 2007

(54) Laptop computer screen night vision apparatus

(76) Inventor: William Thomas Browning, New York, NY (US)

Correspondence Address: BARBER LEGAL, P.O. BOX 16220, GOLDEN, CO, 80402-6004, US

(21) Appl. No.: 11/207,125

(22) Filed: Aug. 17, 2005

(51) Int. Cl. G02B 5/22

(52) U.S. Cl. 359/885; 359/888

(57) ABSTRACT

The present invention teaches that a biased density filter (one which does not allow all hues to pass equally but rather blocks some and allows others through) may be used over the display of a laptop computer. A conformable light barrier may extend all the way around the edge of the laptop display to prevent light from leaking out the edges of the device. A frame may be used to secure the elements together, and an attachment allows the device to be slipped onto and off of the laptop display part conveniently.

### FIELD OF THE INVENTION

This invention relates generally to computer display devices and specifically to night vision apparatus for computer display devices.

### CROSS-REFERENCE TO RELATED APPLICATIONS

N/A

### STATEMENT REGARDING FEDERALLY FUNDED RESEARCH

This invention was not made under contract with an agency of the US Government, nor by any agency of the US Government.

### BACKGROUND OF THE INVENTION

“Night vision” as traditionally understood did not refer to vision amplification devices but rather to allowing the human eye to adapt to low light conditions and then maintaining that adaptation. The adaptation to dark conditions can be difficult and time consuming to achieve. It is also difficult to maintain. A very bright light may leave after images and phosphine in the eye sight of an individual perceiving the bright light after gaining night vision adaptation.

But even low light sources may be too bright to permit night vision to continue. A particular problem occurs when an individual needs to see a mechanical or electronic device while night vision adapted. Normal lighting displays are designed to allow easy vision against a busy city backdrop of headlights and neon signs rather than the darker conditions of night adaptation.

One type of display which would ordinarily be considered dim is the typical laptop computer back light, which is normally designed for use in conditions normally described as dim. The display may be extremely bright to an individual using the display in extreme dark. Astronomers for example need to access information and displays of lap top computers while their eyes are night adapted. But the back light is quite dazzling to an individual with night adapted vision: after briefly viewing a laptop screen, an astronomer may see nothing but a bright rectangle for several minutes afterwards when they need to be examining dim astral bodies. Most laptop computers allow the user to turn the back light off . . . however the LCD screen of a typical laptop actually produces no light of its own, thus rendering the display entirely black in dark conditions.

Some types of laptops do allow the user to dim the display to various levels. These levels may not be the proper degree of dimness, however. In addition, there is the issue of hue, rather than intensity of light.

Certain hues of light (red being the prime example) are advantageous under dark conditions. Red light's energy level may not excite the human optic apparatus as much as other hues/colors/shades of light, thus allowing its use when other colors would dazzle the viewer. In addition, red light is often advantageous for light sensitive equipment, film and so on.

The applicant is presently aware of no hue biased filtering arrangement for laptop computers, none able to be removed and attached easily, none which present a complete and none which offer a total light barrier around the edges of a biased density filter.

U.S. Pat. No. 5,227,916 issued Jul. 13^{th}, 1993 to Theirl et al for ADJUSTABLE MOUNTING MECHANISM FOR AN OPTICAL FILTER SCREEN does not teach any of these: it is a mounting arrangement for a computer screen having a filter across it. It does not teach a complete light barrier around the edges of the screen, does not teach a color filter and so on.

U.S. Pat. No. 5,268,788 issued Dec. 7^{th} 1993 to Fox et al for DISPLAY FILTER ARRANGEMENTS deals with light amplification technology and thus teaches away from light reduction technology.

U.S. Pat. No. 5,754,259 to Nakamatsu et al entitled OPTICAL FILTER FOR VISUAL DISPLAY TERMINALS teaches a filter for CRT type monitors.

U.S. Pat. No. 5,764,209 to Hawthorne et al teaches an electronic device for production of LDC type units, as does U.S. Pat. No. 5,922,401 to Kashiwazaki et al.

U.S. Pat. No. 6,262,843 issued Jul. 17^{th}, 2001 to Marx for POLARIZING PRIVACY SYSTEM FOR USE WITH A VISUAL DISPLAY TERMINAL teaches a polarizing filter (for example, for glare from sunlight or other bright sources) for a VDT. U.S. Pat. No. 6,419,367 issued Jul. 16^{th}, 2002, to Dion et al, GLARE SHIELD ATTACHMENT FOR A LIQUID CRYSTAL DISPLAY SCREEN is directed to the same objectives.

U.S. Pat. No. 6,552,850 (Apr. 22^{rd}, 2002, inventor Dudasik) is another privacy screen type device for banking machines.

U.S. Pat. No. 6,597,346 issued Jul. 22^{nd}, 2003 to Havey et al for HAND HELD COMPUTER WITH SEE THROUGH DISPLAY teaches a see through display for a computer.

No combination of these appears to teach the structures of the invention.

### SUMMARY OF THE INVENTION

General Summary

The present invention teaches that a biased density filter (one which does not allow all hues to pass equally but rather blocks some and allows others through) may be used over the display of a laptop computer. A conformable light barrier may extend all the way around the edge of the laptop display to prevent light from leaking out the edges of the device. A frame may be used to secure the elements together, and an attachment allows the device to be slipped onto and off of the laptop display part conveniently.

Summary in Reference to Claims

It is therefore a first aspect, advantage, objective and embodiment of the invention to provide a night vision saver for a laptop computer having a top part, the top part having a front, the front having a display having a first width and a first height, the top part having a back side and a top edge having a first thickness, the night vision saver comprising:
an attachment dimensioned and configured to attach to such top part;
a biased density filter dimensioned and configured to cover such front display, the attachment secured to the biased density filter; and
a conformable light barrier disposed at all edges of such front display.

It is therefore another aspect, advantage, objective and embodiment of the invention to provide a vision saver wherein the conformable light barrier further comprises:
a foam strip secured to the night vision saver.

It is therefore another aspect, advantage, objective and embodiment of the invention to provide a vision saver wherein the biased density filter further comprises:
a red filter passing a first percentage of red light generated by such display and blocking a first percentage of light of other hues generated by such display.

It is therefore another aspect, advantage, objective and embodiment of the invention to provide a vision saver wherein the biased density filter further comprises:
a sheet of acrylic polymer of the hue of light to be passed.

It is therefore another aspect, advantage, objective and embodiment of the invention to provide a vision saver wherein the attachment further comprises:
a hanger passing across such top edge.

It is therefore another aspect, advantage, objective and embodiment of the invention to provide a vision saver wherein the attachment further comprises:
a tacky material disposed between the night vision saver and such front of such top part.

It is therefore another aspect, advantage, objective and embodiment of the invention to provide a vision saver wherein the attachment further comprises:
at least one hook passing across such top edge, the barb of such hook disposed at such back of such display.

It is therefore another aspect, advantage, objective and embodiment of the invention to provide a vision saver further comprising:
a frame having at least one edge, the frame disposed at and connected to at least one corresponding edge of such biased density filter;
the attachment attached to such biased density filter by such frame;
the conformable light barrier attached to the edge of such frame.

It is therefore another aspect, advantage, objective and embodiment of the invention to provide a vision saver wherein such hanger has a depth, such depth being at least equal to such first thickness.

It is therefore another aspect, advantage, objective and embodiment of the invention to provide a vision saver wherein such biased density filter has a width, such width being at least equal to such first width.

It is therefore another aspect, advantage, objective and embodiment of the invention to provide a vision saver wherein such biased density filter has a height, such height being at least equal to such first height.

It is therefore another aspect, advantage, objective and embodiment of the invention to provide a vision saver wherein the foam strip has a depth of at least 3/16 inch.

### BRIEF DESCRIPTION OF THE DRAWINGS

FIG. 1 is an oblique frontal perspective view of a first embodiment of the invention.

FIG. 2 is an oblique frontal perspective view of a second embodiment of the invention.

FIG. 3 is a side view of a third embodiment of the invention, more clearly showing the structure of the invention.

FIG. 4 is a side view of the third embodiment of the invention in use on a laptop screen (laptop body omitted for clarity).

FIG. 5 is an oblique frontal perspective view of a fourth embodiment of the invention on use on a laptop computer.

FIG. 6 is an oblique frontal perspective view of a sixth embodiment of the invention lacking a frame.

INDEX TO REFERENCE NUMERALS

| | |
|---|---|
| First embodiment | 100 |
| Filter | 102 |
| Frame | 104 |
| Conformable light barrier | 106 |
| Hanger | 108 |
| Hanger extension | 110 |
| Second embodiment | 200 |
| Biased density filter | 202 |
| Frame | 204 |
| Light barrier | 206 |
| Hanger | 208 |
| Hanger extension | 210 |
| Third embodiment | 300 |
| Frame | 304 |
| Foam light barrier | 306 |
| Hook | 308 |
| Barb | 310 |
| Laptop computer display | 420 |
| Display top edge | 422 |
| Display front surface | 424 |
| Display side controls/ports | 426 |
| Adhesive fifth embodiment | 500 |
| Red filter | 502 |
| Laptop | 600 |
| Laptop computer display | 620 |
| Night vision compatible display | 628 |
| Laptop controls | 630 |
| Sixth embodiment | 700 |
| Biased density filter | 702 |
| Light barrier | 706 |
| Hanger | 708 |
| Hanger extension | 710 |

### DETAILED DESCRIPTION

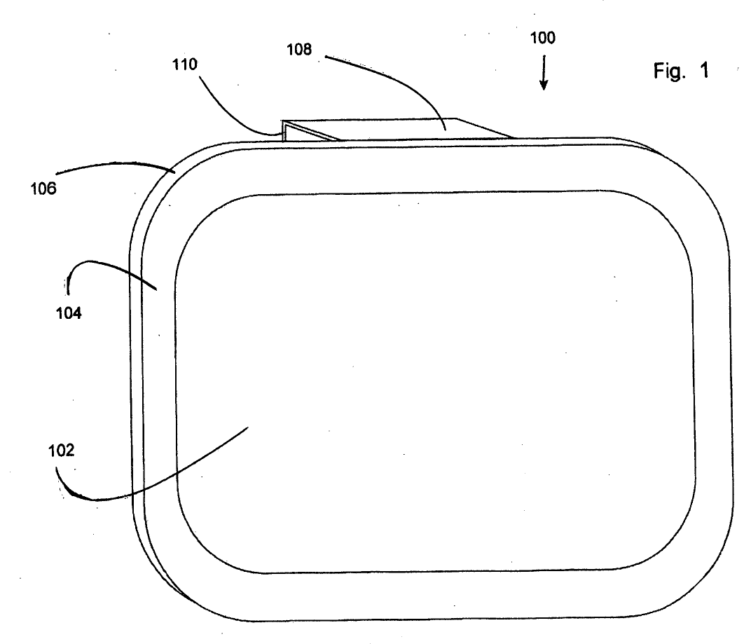

FIG. 1 is an oblique frontal perspective view of a first embodiment of the invention. First embodiment 100 has filter 102, frame 104 holding filter 102, and conformable light barrier 106 also attached to frame 104. Filter 102 may be any type of non-neutral (biased) density filter which blocks one hue (wavelength) of light but not another. For purposes of the present invention, the blocking may be partial or whole, so long as a first percentage of the light of hues other than red is blocked. A second percentage of the light of the desired color may be blocked, and this second percentage may be lower than the first percentage. Thus if the desired color is red, the second percentage (of red light filtered) may be low enough so that red hues continue to penetrate the filter for viewing, while the first percentage of light of other hues which is blocked may higher, thus allowing little or no light of other colors to escape.

In this regard, it is worth noting that the filtering may be very specific in the case of LCD devices which produce color by mixing a small number of LCD elements of different colors together to produce a wider variety of colors. If an LCD device produces only three shades of color (one in each of three LCD layers, for example, red, yellow, and cyan) then a precision blocking of only two frequencies of light may have the desired effect of leaving only the third frequency to penetrate.

Hanger 108 may be a simple track or rail shape and may attach directly to the filter 102 or the frame 104. Hanger extension 110 may extend downwards from the hanger 108 to provide a secure but temporary attachment of the device to a laptop top part which has a display such as an LCD display on the front of the top part.

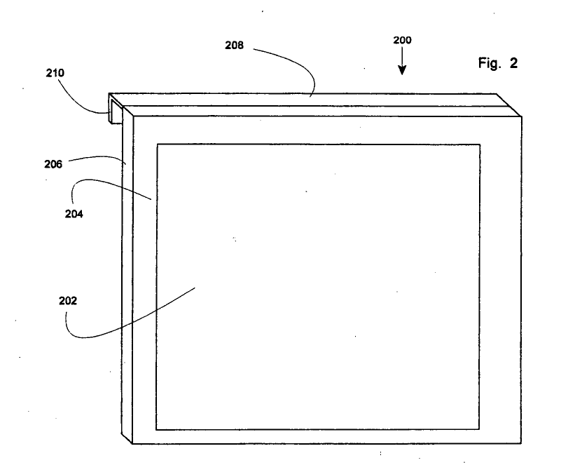

FIG. 2 is an oblique frontal perspective view of a second embodiment of the invention. Second embodiment 200 has biased density filter 202 in frame 204 and has light barrier 206 disposed so as to prevent leakage of light from around the edges of the filter 202 and/or frame 204. Hanger 208 and hanger extension 210 may allow the device to “hang” from the top edge of a laptop top part. (A typical “clamshell” design laptop has a top half with a display therein and a bottom half with a keyboard and other controls therein.)

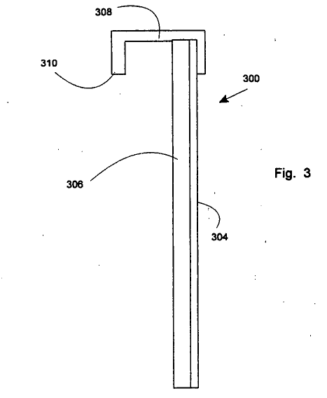

FIG. 3 is a side view of a third embodiment 300 of the invention, more clearly showing the structure of the invention. In this, the presently preferred embodiment and best mode presently contemplated for carrying out the invention, frame 304 may have secured thereto in a permanent manner foam light barrier 306. The foam of the light barrier 306 may be at least 3/16″ thick (roughly 4-5 millimeters), may advantageously be 7/16″ (roughly 10-12 millimeters) thick, or may be a greater thickness as well, such as ¾″ thick. The foam is conformable in that it will conform to the shape of what it is pressed against at even very modest levels of pressure.

Hook 308 may be a hook having a barb 310, and may be replicated: there may be two or more hooks.

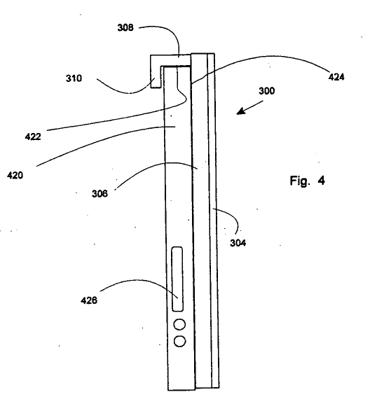

FIG. 4 is a side view of the third embodiment of the invention in use on a laptop screen (laptop body omitted for clarity).

Hook 308 attaches to the top edge of the top part of the laptop, with barb 310 extending down the back side of the top part. Display top edge 422 may have a first thickness, hook 308 may be at least as long, or longer, than this thickness, so that the device may easily hang from the display part of the laptop. Display front surface 424 is depicted straight for the sake of clarity, but it may have controls, ornamentation and so on thereon: foam 306 will conform thereto under the modest weight of the device. Display side controls/ports 426 located on the side of the top part, however, will still be completely accessible.

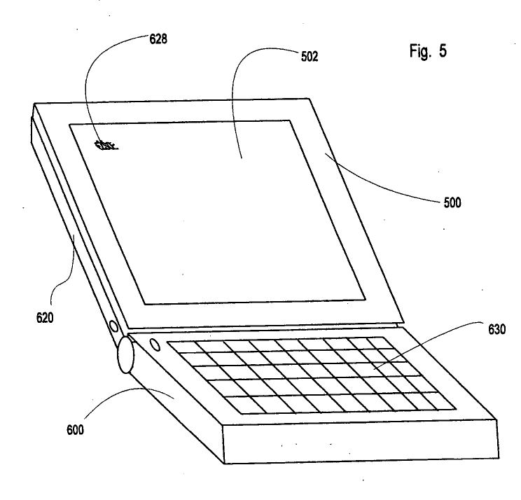

FIG. 5 is an oblique frontal perspective view of a fourth embodiment of the invention on use on a laptop computer. Adhesive fifth embodiment 500 may be adhered to the front side of the top part of the computer, or even to the display itself, by a “tacky” adhesive. (“Tackiness” is a technical description of an adhesive which may be removed and applied again. Note pads such as POST-IT brand notes (Trademark of 3M Corporation, not associated with applicant) have a strip of “tacky” adhesive along one edge. The tacky adhesive may be secured to the foam, to the edge of the display or even to the display or filter.

Red filter 502 may be seen adhered to the laptop 600 at the area of laptop computer display 620. Laptop controls 630 such as keyboard, buttons, analog input devices and so on may be accessed, since the invention may not extend that far down the laptop.

Laptop computer display 620 may be seen to be considerably dimmed but more importantly, the red filter, which may advantageously be a glass, polymer or acrylic acts to allow passage of red light only, thus preventing the eyes of a night adapted user from being dazzled by the passage of more energetic wavelengths of light. Equipment may be similarly protected by the device of the invention.

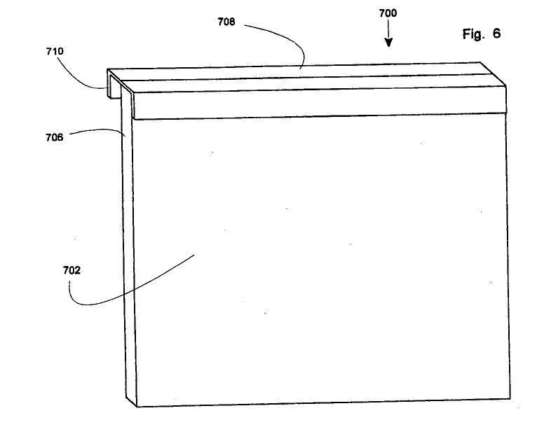

FIG. 6 is an oblique frontal perspective view of a sixth embodiment of the invention lacking a frame. Sixth embodiment 700 has biased density filter 702 which connects directly to hanger 708 having hanger extension 710 without any frame around the edges of the device. This presently preferred embodiment and best mode now contemplated saves weight and also saves cost during manufacturing.

Light barrier 706, a foam, may be attached directly to the edge or rear surface of the filter 702. Filter 702 may have sufficient strength to function without a frame if it is made of sturdy polycarbonate or acrylic material having a biased-density filtering feature (such as a red color). The foam may be slotted so as to allow it to easily slide over the edge of the filter, or it may be “P” cross-sectional foam, slotted, allowing the light barrier to better fit the edge and to provide better light blocking. Thus the frame of the invention may be omitted or may extend along at least one side/edge of the invention and thus the top part of the laptop and display. Since the foam may in alternative embodiments adhere directly to the filter material, the frame may be omitted (in which embodiments the hanger may attach directly to the filter as well).

The filter may be dimensioned and configured to cover the display, so that no light radiates out unfiltered from any part of the display. Advantageously the display may have a first width and first height, and the filter may be as large or larger in both width and height of the filter.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A night vision saver for a laptop computer having a top part, the top part having a front, the front having a display having a first width and a first height, the top part having a back side and a top edge having a first thickness, the night vision saver comprising:
an attachment dimensioned and configured to attach to such top part;
a biased density filter dimensioned and configured to cover such front display, the attachment secured to the biased density filter; and
a conformable light barrier disposed at all edges of such front display.

2. The night vision saver of claim 1, wherein the conformable light barrier further comprises:
a foam strip secured to the night vision saver.

3. The night vision saver of claim 1, wherein the biased density filter further comprises:
a red filter passing a first percentage of red light generated by such display and blocking a first percentage of light of other hues than red generated by such display.

4. The night vision saver of claim 1, wherein the biased density filter further comprises:
a sheet of acrylic of the hue of light to be passed.

5. The night vision saver of claim 1, wherein the attachment further comprises:
a hanger passing across such top edge.

6. The night vision saver of claim 1, wherein the attachment further comprises:
a tacky material disposed between the night vision saver and such front of such top part.

7. The night vision saver of claim 1, wherein the attachment further comprises:
at least one hook passing across such top edge, the barb of such hook disposed at such back of such display.

8. The night vision saver of claim 1, further comprising:
a frame having at least one edge, the frame disposed at and connected to at least one corresponding edge of such biased density filter;
the attachment attached to such biased density filter by such frame;
the conformable light barrier attached to the edge of such frame.

9. The night vision saver of claim 1, wherein such hanger has a depth, such depth being at least equal to such first thickness.

10. The night vision saver of claim 1, wherein such biased density filter has a width, such width being at least equal to such first width.

11. The night vision saver of claim 1, wherein such biased density filter has a height, such height being at least equal to such first height.

12. The night vision saver of claim 2, wherein the foam strip has a depth of at least 3/16 inch.
